(19) United States
(12) Patent Application Publication
(10) Pub. No.: US 2020/0103918 A1
(43) Pub. Date: Apr. 2, 2020

(54) METHOD FOR DETECTING CALLER BY AUTONOMOUS VEHICLE

(71) Applicants: HYUNDAI MOTOR COMPANY, Seoul (KR); KIA MOTORS CORPORATION, Seoul (KR)

(72) Inventor: Won Seok LEE, Seongnam-si (KR)

(73) Assignees: HYUNDAI MOTOR COMPANY, Seoul (KR); KIA MOTORS CORPORATION, Seoul (KR)

(21) Appl. No.: 16/196,082

(22) Filed: Nov. 20, 2018

(30) Foreign Application Priority Data
Oct. 1, 2018 (KR) 10-2018-0117095

(51) Int. Cl. G05D 1/02; G05D 1/00; G01C 21/34; G06Q 10/02; G06Q 50/30; G08G 1/00; G06K 9/00

(52) U.S. Cl. CPC G05D 1/0246; G05D 1/0088; G05D 1/0038; G05D 1/0016; G01C 21/3438; G05D 2201/0213; G06Q 50/30; G08G 1/202; G06K 9/00288; G06K 9/00791; G06K 9/00369; G06Q 10/02

(57) ABSTRACT

A method for detecting a caller by an autonomous vehicle is provided. In particular, when the autonomous vehicle is getting closer to a caller, it transmits an image of a vicinity of the autonomous vehicle to a portable terminal of the caller such that the caller specifies the caller on the received image. The autonomous vehicle autonomously travels to the location of the caller based on the image marked by the caller, thereby inhibiting or preventing the caller from personally detecting the autonomous vehicle.

### CROSS-REFERENCE TO RELATED APPLICATION

This application claims priority to and the benefit of Korean Patent Application No. 10-2018-0117095, filed on Oct. 1, 2018, the entire contents of which are incorporated herein by reference.

### FIELD

The present disclosure relates to a method for detecting a caller by an autonomous vehicle.

### BACKGROUND

The statements in this section merely provide background information related to the present disclosure and may not constitute prior art.

Car Hailing is a kind of a service of sharing a vehicle, which has been spotlighted recently, and is collectively referred to as “vehicle calling service” in a broad sense.

The vehicle calling service is a service directly connecting a customer, who hopes to move, with a service provider owing a vehicle, and “Uber”, which is started in the United States, is a representative example. In Korea, currently, “Cacao Taxi” is a business model similar to “Uber”.

According to a manner of operating the vehicle calling service, if a caller calls a vehicle through a smart phone of the caller, the location of the caller is transmitted to a smart phone of a vehicle driver, and the vehicle driver moves a vehicle to a location marked on a map, thereby allowing the caller to take a vehicle. In this case, since global positioning system (GPS) information has a distance error, the vehicle driver may not recognize the location of the caller. In addition, since the vehicle driver does not know the face of the caller, when the vehicle arrives in a vicinity of the caller, the vehicle driver specifies the caller by calling the caller or transmitting or receiving a text message.

Since the autonomous vehicle having developed recently has an ability to travel to a destination without the involvement of a driver, the autonomous vehicle maybe used for various purposes, and, especially, used even for the vehicle calling service.

In this case, in the absence of the driver in the autonomous vehicle, the autonomous vehicle has to directly detect the caller, but such a technology has never been suggested yet.

### SUMMARY

The present disclosure has been made to solve the above-mentioned problems occurring in the prior art while advantages achieved by the prior art are maintained intact.

An aspect of the present disclosure provides a method for detecting a caller by an autonomous vehicle, which allows the autonomous vehicle closer to the caller to transmit an image of a vicinity of the autonomous vehicle to a portable terminal of the caller such that the caller specifies himself/herself on the image, and to autonomously travel to the location of the caller based on the image marked by the caller, thereby preventing the caller from personally detecting the autonomous vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a method for detecting a caller by an autonomous vehicle includes: receiving, by a detection controller of the autonomous vehicle, from a portable terminal of the caller, an image of the caller that is marked thereon, identifying, by the detection controller, the caller among images obtained by capturing a vicinity of the caller, based on the image having the marked caller, and moving the autonomous vehicle to a location of the identified caller.

The method may further include moving, before receiving the image having the marked caller, the autonomous vehicle to the vicinity of the caller based on information of a location of the portable terminal of the caller when a call from the portable terminal is received, and capturing, by an image device of the autonomous vehicle, the images of the vicinity of the caller and transmitting the images of the vicinity of the caller to the portable terminal of the caller.

In addition, identifying the caller may include setting a region having the marked caller as a template on the image of the caller, capturing a new vicinity image, and identifying the caller through template matching between the image having the marked caller and the new vicinity image.

In addition, identifying the caller may include identifying the caller by recognizing the face of the caller.

In addition, the method may further include transmitting a message of notifying arrival to the portable terminal after moving to the location of the identified caller, or may further include notifying arrival through a display mounted on an outer portion of the autonomous vehicle after moving to the location of the identified caller.

According to another aspect of the present disclosure, a method for detecting a caller by an autonomous vehicle includes: receiving, by a detection controller of the autonomous vehicle, from a portable terminal of the caller, a three dimensional (3D) image of the caller that is marked thereon, extracting, by a controller of the autonomous vehicle, a distance to the caller from the 3D image having the marked caller, and moving the autonomous vehicle, based on the extracted distance, to the caller.

The method may further include: moving, before receiving the 3D image having the marked caller, the autonomous vehicle to a vicinity of the caller based on information of a location of the portable terminal of the caller, when a call from the portable terminal is received, and capturing by an image device of the autonomous vehicle, a 3D image of the vicinity of the caller and transmitting the 3D image captured the vicinity of the caller to the portable terminal of the caller.

In addition, the method may further include transmitting a message of notifying arrival to the portable terminal of the caller after traveling the extracted distance to the caller, or may further include notifying arrival through a display mounted on an outer portion of the autonomous vehicle after traveling the extracted distance to the caller.

According to another aspect of the present disclosure, a method for detecting a caller by an autonomous vehicle includes: receiving, by a detection controller of the autonomous vehicle, from a portable terminal of the caller, an electronic map having a location of the caller that is marked thereon; calculating, by a controller of the autonomous vehicle a distance to the caller on the electronic map having the marked location of the caller; and moving the autonomous vehicle based on the extracted distance to the caller.

According to the present disclosure, another method may further include: moving, before receiving the electronic map having the marked location of the caller, the autonomous vehicle to a vicinity of the caller based on information of a location of the portable terminal of the caller, when a call from the portable terminal is received, and marking a present location on the electronic map when the autonomous vehicle arrives in the vicinity of the caller, and transmitting the marked present location of the autonomous vehicle to the portable terminal.

In this case, the present location marked on the electronic map may be displayed on the portable terminal of the caller with a vehicle icon, and the vehicle icon may have the same color as a color of the autonomous vehicle, and may represent a vehicle having the same type as a type of the autonomous vehicle.

In addition, the electronic map may be a detailed map showing obstacles in a vicinity of a present location, and the obstacles may have identifiers (IDs).

According to the present disclosure, another method may further include transmitting a message of notifying arrival to the portable terminal after traveling the extracted distance to the caller, or may further include notifying arrival through a display mounted on an outer portion of the autonomous vehicle after traveling the extracted distance to the caller.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a schematic diagram of an autonomous vehicle;

FIG. 2 is a flowchart illustrating a method for detecting a caller by an autonomous vehicle;

FIG. 3 is a flowchart illustrating a method for detecting a caller by an autonomous vehicle;

FIG. 4 illustrates an image having a caller marked thereon;

FIG. 5 illustrates a 3D image;

FIG. 6 illustrates an image including distance information;

FIG. 7 is a flowchart illustrating a method for detecting a caller by an autonomous vehicle; and

FIG. 8 is a block diagram illustrating a computing system to implement the method for detecting the caller by the autonomous vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, in the following description of an exemplary form of the present disclosure, a detailed description of well-known features or functions will be ruled out in order not to unnecessarily obscure the gist of the present disclosure.

In describing elements of exemplary forms of the present disclosure, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific teams, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

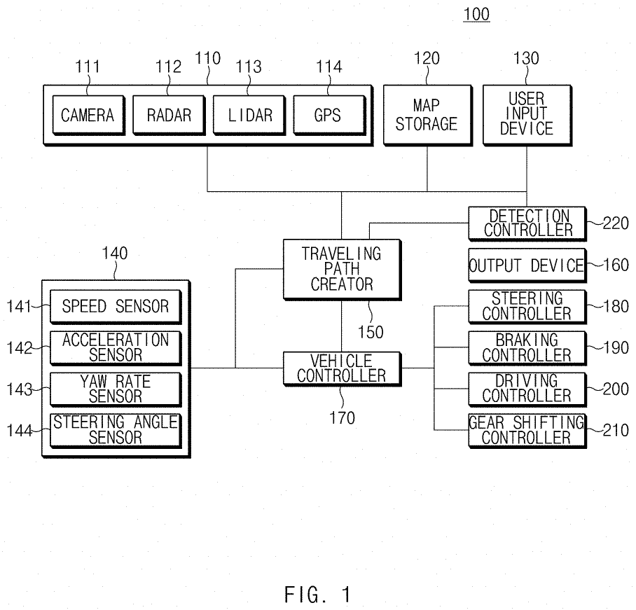

FIG. 1 illustrates a schematic diagram of an autonomous vehicle to which the present disclosure is applied.

As illustrated in FIG. 1, the autonomous vehicle may include: a sensor 110, a map storage 120, a user input device 130, a vehicle sensor 140, a traveling path creator 150, an output device 160, a vehicle controller 170, a steering controller 180, a braking controller 190, a driving controller 200, a gear shifting controller 210, and a detection controller 220. Depending on a manner of reproducing the present disclosure, components are coupled to each other to be unified in one component. In addition, some components may be omitted depending on the manner of reproducing the present disclosure

In this case, the traveling path creator 150, the vehicle controller 170, the steering controller 180, the braking controller 190, the driving controller 200, the gear shifting controller 210, and the detection controller 220 may include a processor (not illustrated) and a memory (not illustrated). The traveling path creator 150, the vehicle controller 170, the steering controller 180, the braking controller 190, the driving controller 200, the gear shifting controller 210, and the detection controller 220 may transmit and receive data (information) through a vehicle network such as a controller area network (CAN), a media oriented systems transport (MOST) network, a local interconnect network (LIN), or an X-by-Wire (Flexray)

The sensor 110 acquires surrounding information on the vicinity the vehicle. In this case, the surrounding information includes the distance between a subject vehicle and a rear vehicle, the relative speed of the rear vehicle, the location (of the advancing vehicle) of the front vehicle, an obstacle, and information on a traffic light.

The sensor 110 may include a camera 111, a radar 112, a LiDAR 113, and a global positioning system (GPS) 114. In this case, the camera 111 may include an infrared camera, a stereo camera, and a 3D camera, and the LiDAR 113 may include a 2D LiDAR and a 3D LiDAR. In addition, the sensor 110 detects a vicinity image of the vehicle, the distance between a subject vehicle and a rear vehicle, the relative speed of the rear vehicle, the location (of the advancing vehicle) of the front vehicle, an obstacle, and/or information on a traffic light through the camera 111, the radar 112, and the LiDAR 113, and detects the present location of the subject vehicle through a GPS 114. In addition, the sensor 110 may further include an ultrasonic sensor.

The map storage 120 stores, in the form of the database (DB), a detailed map based on lanes. The detailed map may be automatically updated at a specific period through wireless communication or may be manually updated by a user.

The map storage 120 may be implemented with at least any one of a flash memory, a hard disk, a secure digital (SD) card, a random access memory (RAM), a read only memory (ROM), or a web-storage.

The user input device 130 may generate data input by a ser. For example, the user input device 130 generates destination information (e.g., the name of a place and/or coordinates). The user input device 130 may include a keypad, a dome switch, a touch pad, a jog wheel, and/or a jog switch.

The vehicle sensor 140 measure vehicle information on the subject vehicle. The vehicle information includes the speed, the acceleration, the yaw rate, and the steering angle of the subject vehicle. The vehicle sensor 140 may include a speed sensor 141, an acceleration sensor 142, a yaw rate sensor 143, and a steering angle sensor 144.

The traveling path creator 150 creates the traveling path (global path) for the autonomous traveling of the vehicle. The traveling path creator 150 creates the traveling path from the present location of the subject vehicle to the destination, if the destination is input through the user input device 130. In this case, the traveling path creator 150 creates the traveling path based on the detailed map and/or the information on the real-time traffic acquired through the wireless communication. The wireless communication technology may include the wireless Internet, mobile communication, or broadcasting communication.

The traveling path creator 150 recognizes (determines) the situation of a packet lane based on the surrounding information when the vehicle enters the pocket lane region (a region for entering the pocket lane) on the front path during the autonomous traveling. In other words, the traveling path creator 150 recognizes the traffic congestion on the pocket lane, the distance between the rear vehicle and the subject vehicle, the relative speed of the rear vehicle, or the color of the traffic lamp, which is turned on, based on data measured by the sensor 110. The traveling path creator 150 determines if the subject vehicle is able to stop on a linear traveling lane (linear lane) to enter the pocket lane by analyzing the recognized situation of the pocket lane. The traveling path creator 150 planes the traveling path in the pocket lane region depending on the recognized situation of the pocket lane.

The traveling path creator 150 controls the vehicle controller 170 to be described later, turns on a turn indicator, decelerates the speed of the vehicle, and determines whether the front vehicle is present on the pocket lane, when the subject vehicle is able to stop on the linear lane for entering the pocket lane.

When there is present a front vehicle on the pocket lane, the traveling path creator 150 detects the location of the front vehicle on the pocket lane to determine whether the entrance to the pocket lane on the traveling path is possible. The traveling path creator 150 provides an existing traveling path, which is preset, to the vehicle controller 170 when the entrance to the pocket lane on the traveling path is possible

The traveling path creator 150 creates a tracking path (front vehicle tracking path) to the front vehicle and provides the front vehicle tracking path to the vehicle controller 170, when it is difficult to enter the pocket lane on the traveling path. Accordingly, the vehicle controller 170 controls the traveling of the subject vehicle such that the subject vehicle tracks to the front vehicle based on the front vehicle tracking path.

The traveling path creator 150 creates a new traveling path by detecting the new traveling path for arriving at a preset destination through the traveling on the linear traveling lane, when it is difficult for the subject vehicle to stop on the linear traveling path to enter the pocket lane (entrance to the pocket lane). The traveling path creator 150 transmits the created new traveling path to the vehicle controller 170.

The traveling path creator 150 creates a traveling path to the pace that the caller, which calls the autonomous vehicle, is located

The output device 160, which is to output visual information, auditory information and/or tactile information, may include a display, a sound output module, and a haptic module. For example, the output device 160 allows the traveling path, which is output from the traveling path creator 150, to overlap with the detailed map and to display the overlap result.

The output device 160 may output, in the form of a voice signal, a warning message or a notification message under the control of the traveling path creator 150.

In addition, the output device 160 may further include a display and an electronic board mounted on an outer portion of the autonomous vehicle to display the information on the caller (for example, a photo, a phone number, an identifier, an intrinsic number, a one-time code, or the like) such that the caller more easily recognizes the autonomous vehicle.

The vehicle controller 170 controls the vehicle to autonomously travel along the traveling path created by the traveling path creator 150. The vehicle controller 170 obtains vehicle information from the vehicle sensor 140 and performs vehicle control based on the obtained vehicle information.

In addition, the vehicle controller 170 controls the vehicle to autonomously travel to the place that the caller is located.

The steering controller 180 is implemented through Motor Drive Power Steering (MDPS) to control the steering of the vehicle. The steering controller 180 controls the steering angle of the vehicle under the control of the vehicle controller 170.

The braking controller 190 is implemented through Electronic Stability Control (ESC) to control the speed of the vehicle. The braking controller 190 controls braking pressure depending on the position of the brake pedal or controls the braking pressure under the control of the vehicle controller 170.

The driving controller 200, which is a device to control an engine of the vehicle, controls the acceleration or the deceleration of the vehicle. The driving controller 200 is implemented with an Engine Management System (EMS). The driving controller 200 controls driving torque of an engine depending on the information on the position of an acceleration pedal. In addition, the driving controller 200 controls an engine output to follow a target driving torque desired from the vehicle controller 170.

The gear shifting controller 210 is in charge of shifting of a gear (gear step) of the vehicle. The gear shifting controller 210 is implemented with an electronic shifter or the Shift by Wire (SBW).

The detection controller 220 captures an image of a vicinity of the autonomous vehicle through the camera 111 when the vehicle approaches the place that the caller is located, transmits the captured image to a portable terminal 300 of the caller through wireless communication such that the caller specifies the caller captured on the image. In other words, the caller that has received the image through the portable terminal 300 specifies the caller captured on the image and then transmits an image having the caller that is marked thereon to the autonomous vehicle. In this case, when the caller is absent from the image, the caller may transmit a notification that the caller is absent from the image or may requests for transmission of a new image.

The detection controller 220 creates a traveling path while interworking with the traveling path creator 150 such that the vehicle autonomously travels to the location of the caller, based on the image having the marked caller. In this case, the detection controller 220 may detect the caller while moving, based on pattern matching, face recognition, or the like. The location of the caller, which is detected in such a manner, becomes a destination of the autonomous vehicle.

The detection controller 220 arrives at the point (in detail, there may be an error due to GPS information) that the portable terminal 300 of the caller is located, captures an image of a vicinity of the autonomous vehicle, and then transmits the image to the portable terminal 300 of the caller. The detection controller 220 receives the image having the marked caller from the portable terminal 300 of the caller, compares a currently captured image with the image having the marked caller while slowly traveling, and traces the caller. In other words, the detection controller 220 identifies the caller from images captured in the vicinity of the caller.

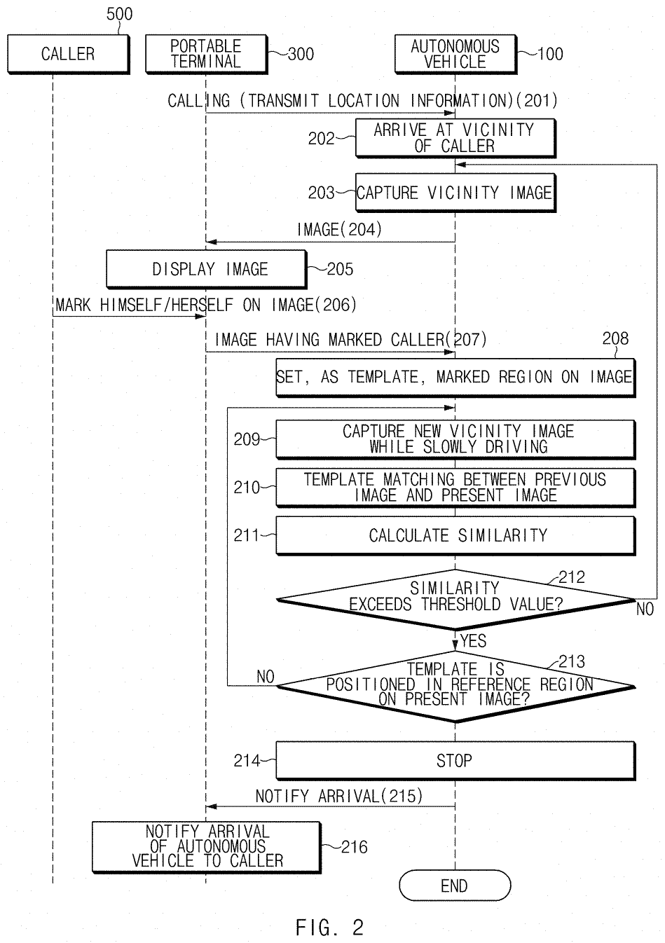

FIG. 2 is a flowchart illustrating a method for detecting the caller by the autonomous vehicle, according to a first form of the present disclosure.

First, a portable terminal 300 calls an autonomous vehicle 100 in response to a request received from a caller 500 (201). In this case, the portable terminal 300 transmits information on the location of the portable terminal 300 to the autonomous vehicle 100. In addition, since the portable terminal 300 includes a GPS receiver, the portable terminal 300 may obtain the information (GPS location information) on the location of the portable terminal 300.

Thereafter, the autonomous vehicle 100 sets, as a destination, a point corresponding to the GPS location information received from the portable terminal 300 and arrives at the destination through the autonomous traveling (202). In this case, since the GPS location information has an error, the autonomous vehicle 100 may not arrive at the location of the caller 500 (for example, within 2 m). In other words, the autonomous vehicle 100 may arrive at the vicinity of the caller 500.

Thereafter, the autonomous vehicle 100 captures an image (photo) in the vicinity of the caller 500 (203) In this case, although it may be considered that the autonomous vehicle 100 captures an image of a front portion of the autonomous vehicle 100, the autonomous vehicle 100 may capture an image of a side portion or a rear portion of the autonomous vehicle 100 according to the need.

Thereafter, the autonomous vehicle 100 transmits the captured image to the portable terminal 300 (204) and the portable terminal 300 displays the image which is received therein (205). The caller 500 searches for and marks himself/herself on an image displayed on the portable terminal 300 (206). In this case, the caller 500 may request for the transmission of a new image when the caller 500 cannot search for himself/herself on the received image. In this case, the new image may refer to an image newly captured by the autonomous vehicle 100 slowly traveling.

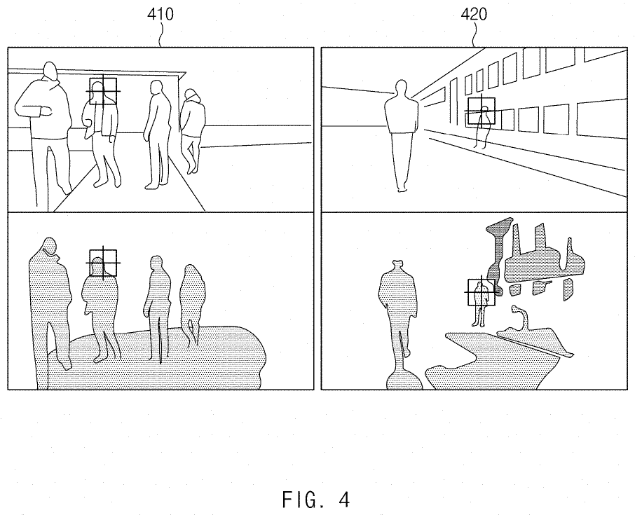

Then, the portable terminal 300 transmits an image having the caller 500 that is marked thereon to the autonomous vehicle 100 (207). In this case, the image having the marked caller 500 is, for example, as illustrated in reference numerals 410 and 420 of FIG. 4.

Thereafter, the autonomous vehicle 100 traces the caller 500 by comparing the image having the marked caller 500 with the image newly captured by the autonomous vehicle 100 slowly traveling.

Hereinafter, the procedure of tracing the caller 500 through the image by the autonomous vehicle 100 slowly traveling will be described in detail.

The autonomous vehicle 100 sets, as a template, a marked region on the image received from the portable terminal 300 (208) and periodically captures a new vicinity image while slowly traveling (209). In this case, the procedure of setting the template may include the procedure of recognizing the face, the hair style, or the clothes color of the caller in the marked region.

In addition, the autonomous vehicle 100 performs template matching between a previous image (the image having the marked caller) and a prevent image (newly captured image) (210).

Since the template matching is performed at sufficiently short time intervals, the similarity representing the matching result exceeds a threshold value except a special case. In this case, the present image may be an image captured within a short period of time (for example, 0.5 second, one second, or the like) after the previous image is captured. In addition, the size (R) of a target region on an image subject to the template matching may be determined based on the viewing angle and the resolution of the camera 111, the speed of the vehicle, the operating period (the number of frames per second), or the size of the template. For example, when the operating period is 20 frames per second, the viewing angle of the camera 111 is 100 degrees, the resolution of the camera 111 is 2M, the speed of the vehicle is 15 KPH, and the size of the template is 20 pixels, the size of the target region within the image may be determined to 40 pixels.

Thereafter, the autonomous vehicle 100 calculates the similarity based on the template matching result (211). The procedure of calculating the similarity may be performed through various technologies which are well-known.

Thereafter, the autonomous vehicle 100 determines whether the similarity exceeds the threshold value (212).

When the similarity does not exceed the threshold value as in the determination result (212), operation 203 is performed. When the similarity exceeds the threshold value, it is determined that the template is positioned in the reference region on the present image (213).

When the template is not positioned in the reference region as in the determination result 213, the operation 209 is performed and the above procedure is repeated. When the template is positioned in the reference region, the autonomous vehicle 100 stops (214).

In addition, the notification that the autonomous vehicle 100 arrives at the location of the caller 500 is transmitted to the portable terminal 300 (215). Then, the portable terminal 300 displays the notification such that the caller 500 takes a notice (216).

Operations 209 to 213 repeated in the first form of the present disclosure are procedures of tracing the caller on an image through the repeated template matching between the previous image and the present image. For example, when the similarity exceeds the threshold value, in which the similarity is obtained by detecting the template of a first image from a second image based on the template matching (similarity) between the first image (the image having the marked caller) and the second image (the image captured thereafter), the template on the second image is set as a new reference and the template matching is performed between the second image and a third image (the image captured after the second image). When the template is positioned in the reference region as the above procedures are repeatedly performed, the procedure of detecting the caller is terminated.

Although the first form of the present disclosure has been described regarding the procedure of detecting the caller through the template matching, a face recognition manner may be used based on various face photos of the caller previously registered. In other words, the autonomous vehicle 100 may periodically capture a vicinity image after arriving in the vicinity of the caller 500, recognizes the face of the caller from the image having the marked caller. Then, the autonomous vehicle 100 may trace the caller 500 by using images captured thereafter. In this case, the resolution of the camera 111 may be selected from among High Definition (HD), Full HD, Quad High Definition (QHD), and Ultra High Definition (UDH) according to the need.

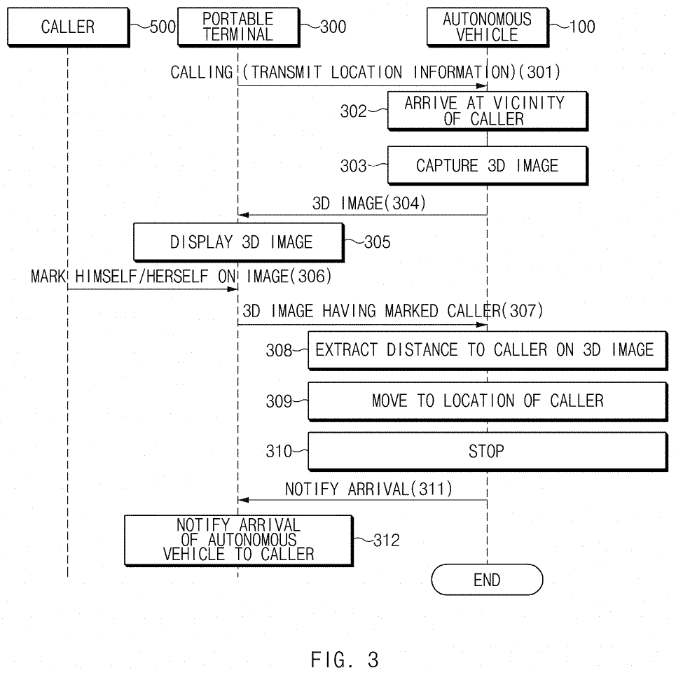

FIG. 3 is a flowchart illustrating the method for detecting the caller by the autonomous vehicle, according to a second form of the present disclosure.

First, a portable terminal 300 calls an autonomous vehicle 100 in response to a request received from a caller 500 (301). In this case, the portable terminal 300 transmits information on the location of the portable terminal 300 to the autonomous vehicle 100. In addition, since the portable terminal 300 includes a GPS receiver, the portable terminal 300 may obtain the information on the location of the portable terminal 300.

Thereafter, the autonomous vehicle 100 sets, as a destination, a point corresponding to the GPS location information received from the portable terminal 300 and arrives at the destination through the autonomous traveling (302). In this case, since the GPS location information has an error, the autonomous vehicle 100 may not arrive at the location of the caller 500 (for example, within 2 m). In other words, the autonomous vehicle 100 may arrive at the vicinity of the caller 500.

Thereafter, the autonomous vehicle 100 captures a three dimensional (3D) image (photo) in the vicinity of the caller 500 (303). The 3D image captured in such a manner is, for example, as in illustrated in FIG. 4. The data of the 3D image includes information on a distance to an object (person) on the image. In this case, although the autonomous vehicle 100 may capture an image of a front portion of the autonomous vehicle 100, the autonomous vehicle 100 may capture an image of a side portion or a rear portion of the autonomous vehicle 100 according to the need.

Thereafter, the autonomous vehicle 100 transmits the captured 3D image to the portable terminal 300 (304) and the portable terminal 300 displays the 3D image which is received therein (305). The caller 500 searches for and marks himself/herself from a 3D image displayed on the portable terminal 300 (306). In this case, the caller 500 may request for the transmission of a new image when the caller 500 cannot search for himself/herself on the received image. In this case, the new image may refer to an image newly captured by the autonomous vehicle 100 slowly traveling.

Then, the portable terminal 300 transmits an image having the caller 500 that is marked thereon to the autonomous vehicle 100 (307).

Thereafter, the autonomous vehicle 100 extracts the distance to the caller 500 from the 3D image and then moves to the location of the caller 500 (308, 309)

Thereafter, the autonomous vehicle 100 stops after arriving at the location of the caller 500 (310). Then, the autonomous vehicle 100 transmits a message of notifying the portable terminal 300 of the arrival. In this case, the autonomous vehicle 100 may notify the portable terminal 300 of the arrival by using the display or the electronic board mounted on the outer portion of the autonomous vehicle 100.

Then, the portable terminal 300 displays the notification such that the caller 500 takes a notice (312).

Although the second form of the present disclosure has been described regarding the manner of obtaining the distance to the caller 500 by using a 3D image captured by the 3D camera, the distance to the caller 500 may be obtained by using a 2D camera and a 3D LiDAR, a 2D camera and a 2D LiDAR, and a 2D camera and a 2D LiDAR. In this case, a back projection manner may be used to create the information on the distance to an object on an image by converting signals, which are measured by the 3D LiDAR, the 2D LiDAR, or the radar, points in the image.

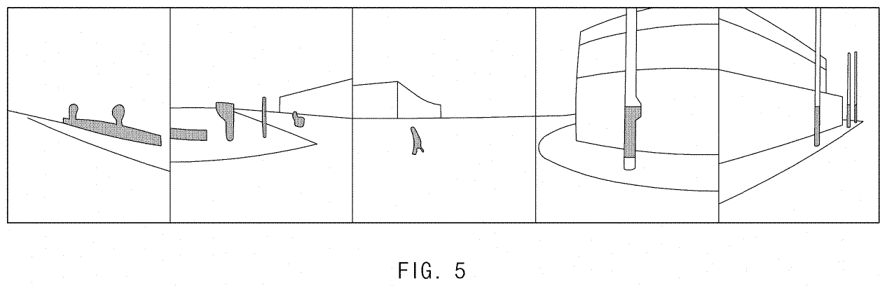

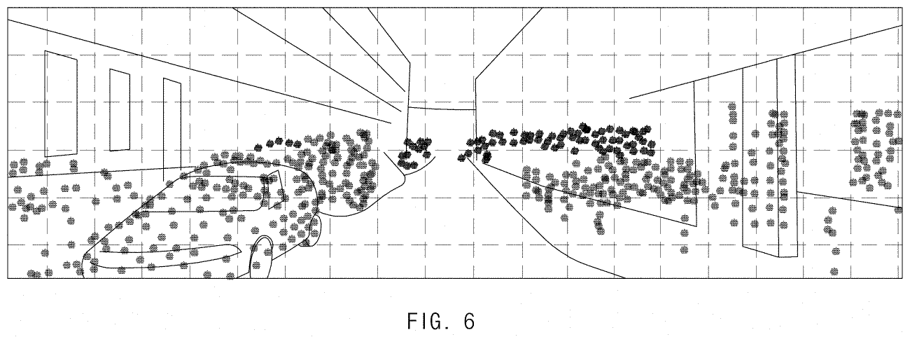

In this case, even if the 3D image is produced as in illustrated in FIG. 5 through the back projection since the 3D LiDAR measures a sufficient amount of distance information (high-density distance information), However, in the case of a 2D LiDAR or the radar, since distance information is limited, the caller is marked only in the region having distance information produced through the back projection such that the distance to the caller is obtained. The image produced in such a manner is as illustrated in FIG. 6.

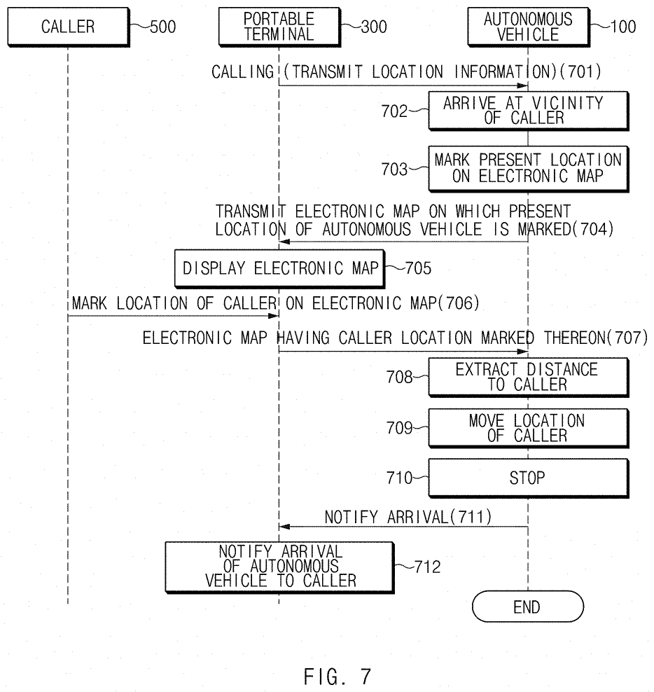

FIG. 7 is a flowchart illustrating the method for detecting the caller by the autonomous vehicle, according to a third form of the present disclosure.

First, a portable terminal 300 calls an autonomous vehicle 100 in response to a request received from a caller 500 (701). In this case, the portable terminal 300 transmits information on the location of the portable terminal 300 to the autonomous vehicle 100. In addition, since the portable terminal 300 includes a GPS receiver, the portable terminal 300 may obtain the information on the location of the portable terminal 300.

Thereafter, the autonomous vehicle 100 sets, as a destination, a point corresponding to the GPS location information received from the portable terminal 300 and arrives at the destination through the autonomous traveling (702). In this case, since the GPS location information has an error, the autonomous vehicle 100 may not arrive at the location of the caller 500 (for example, within 2 m). In other words, the autonomous vehicle 100 may arrive at the vicinity of the caller 500.

Thereafter, the autonomous vehicle 100 marks a present location thereof on an electronic map around the caller 500. In this case, the autonomous vehicle 100 may mark the present location of the autonomous vehicle 100 by using a vehicle icon. In this case, the type (e.g., a sedan, a van, or a truck) of the vehicle of the vehicle icon and the color of the vehicle may be expressed identically to the type and the color of the autonomous vehicle 100. In addition, the electronic map is a detailed map allowing a user to easily recognize the location of the autonomous vehicle 100 as well as the location of the caller 500. In addition, the location of a surrounding obstacle detected by the autonomous vehicle 100 may be displayed. In this case, the ID may be assigned to the obstacle. This electronic map may be a 2D electronic map, a 3D electronic map, or an augmented reality (AR) image.

Thereafter, the electronic map on which the present location of the autonomous vehicle 100 is marked is transmitted to the portable terminal 300 (704). The portable terminal 300 displays the received electronic map (705), and the caller 500 marks the location of the caller 500 on the electronic map displayed by the portable terminal 300 (706).

Thereafter, the portable terminal 300 transmits, to the autonomous vehicle 100, the electronic map on which the location of the caller 500 is marked (707)

Thereafter, the autonomous vehicle 100 extracts the distance to the caller 500 from the electronic map and then moves to the location of the caller 500 (708, 709)

Thereafter, the autonomous vehicle 100 stops after arriving at the location of the caller 500 (710). Then, the autonomous vehicle 100 transmits a message of notifying the arrival to the portable terminal 300 (711). In this case, the autonomous vehicle 100 may notify the arrival to the portable terminal 300 by using the display or the electronic board mounted on the outer portion of the autonomous vehicle 100.

Then, the portable terminal 300 displays the notification such that the caller 500 takes a notice (712).

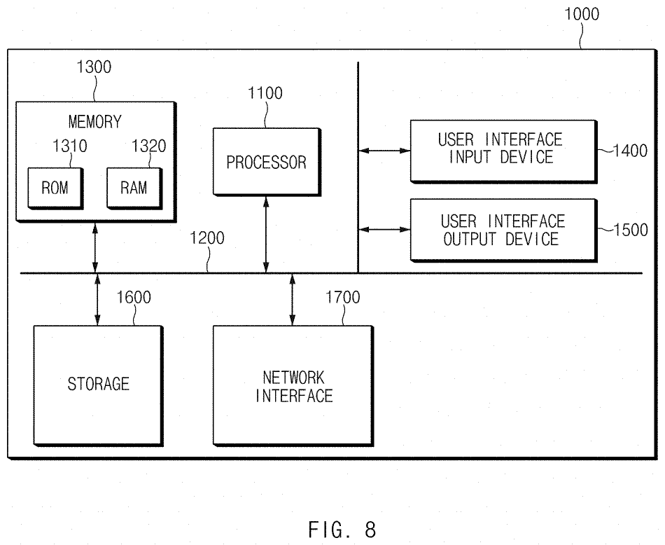

FIG. 8 is a block diagram illustrating a computing system to implement the method for detecting the caller by the autonomous vehicle, according to another exemplary form of the present disclosure.

Referring to FIG. 8, the method for detecting the caller may be implemented through a computing system. A computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the forms disclosed in the specification may be directly implemented with a hardware module, a software module, or combinations thereof, executed by the processor 1100. The software module may reside on a storage medium (e.g., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). An exemplary storage medium may be coupled to the processor 1100. The processor 1100 may read out information from the storage medium and may write information in the storage medium. Alternatively, the storage medium may be integrated with the processor 1100. The integrated processor and storage medium may reside in an application specific integrated circuit (ASIC). The ASIC may reside in a user terminal. Alternatively, the integrated processor and storage medium may reside as a separate component of the user terminal.

As described above, according to the present disclosure, the autonomous vehicle closer to a caller transmits an image of a vicinity of the autonomous vehicle to a portable terminal of a caller such that the caller specifies the caller on an image. In addition, the autonomous vehicle autonomously travels to the location of the caller based on the image marked by the caller, thereby inhibiting or preventing the caller from personally detecting the autonomous vehicle.

While the present disclosure has been described with reference to exemplary forms, it will be apparent to those skilled in the art that various changes and modifications may be made without departing from the spirit and scope of the present disclosure.

Therefore, exemplary forms of the present disclosure are not limiting, but illustrative, and the spirit and scope of the present disclosure is not limited thereto. It should be interpreted that all technical ideas which are equivalent to the present disclosure are included in the spirit and scope of the present disclosure.

What is claimed is:

1. A method for detecting a caller by an autonomous vehicle, the method comprising:
receiving, by a detection controller of the autonomous vehicle, from a portable terminal of the caller, an image of the caller that is marked thereon;
identifying, by the detection controller, the caller among images obtained by capturing a vicinity of the caller, based on the image having the marked caller; and
moving the autonomous vehicle to a location of the identified caller.

2. The method of claim 1, further comprising:
moving, before receiving the image having the marked caller, the autonomous vehicle to the vicinity of the caller based on information of a location of the portable terminal of the caller when a call from the portable terminal is received; and
capturing, by an image device of the autonomous vehicle, the images of the vicinity of the caller and transmitting the images of the vicinity of the caller to the portable terminal of the caller.

3. The method of claim 1, wherein identifying the caller includes:
setting a region having the marked caller as a template on the image of the caller;
capturing a new vicinity image; and
identifying the caller through template matching between the image having the marked caller and the new vicinity image.

4. The method of claim 1, wherein identifying the caller includes:
identifying the caller by recognizing a face of the caller.

5. The method of claim 1, further comprising:
transmitting a message of notifying arrival to the portable terminal after moving to the location of the identified caller.

6. The method of claim 1, further comprising:
notifying arrival through a display mounted on an outer portion of the autonomous vehicle after moving to the location of the identified caller.

7. A method for detecting a caller by an autonomous vehicle, the method comprising:
receiving, by a detection controller of the autonomous vehicle, from a portable terminal of the caller, a three dimensional (3D) image of the caller that is marked thereon;
extracting, by a controller of the autonomous vehicle, a distance to the caller from the 3D image having the marked caller; and
moving the autonomous vehicle, based on the extracted distance, to the caller.

8. The method of claim 7, further comprising:
moving, before receiving the 3D image having the marked caller, the autonomous vehicle to a vicinity of the caller based on information of a location of the portable terminal of the caller, when a call from the portable terminal is received; and
capturing by an image device of the autonomous vehicle, a 3D image of the vicinity of the caller and transmitting the 3D image captured the vicinity of the caller to the portable terminal of the caller.

9. The method of claim 7, further comprising:
transmitting a message of notifying arrival to the portable terminal of the caller after traveling the extracted distance to the caller.

10. The method of claim 7, further comprising:
notifying arrival through a display mounted on an outer portion of the autonomous vehicle after traveling the extracted distance to the caller.

11. A method for detecting a caller by an autonomous vehicle, the method comprising:
receiving, by a detection controller of the autonomous vehicle, from a portable terminal of the caller, an electronic map having a location of the caller that is marked thereon;
calculating, by a controller of the autonomous vehicle, a distance to the caller on the electronic map having the marked location of the caller; and
moving the autonomous vehicle based on the extracted distance to the caller.

12. The method of claim 11, further comprising:
moving, before receiving the electronic map having the marked location of the caller, the autonomous vehicle to a vicinity of the caller based on information of a location of the portable terminal of the caller, when a call from the portable terminal is received; and
marking a present location of the autonomous vehicle on the electronic map when the autonomous vehicle arrives in the vicinity of the caller, and transmitting the marked present location of the autonomous vehicle to the portable terminal.

13. The method of claim 12, wherein the present location marked on the electronic map is displayed on the portable terminal of the caller with a vehicle icon.

14. The method of claim 13, wherein the vehicle icon has the same color as a color of the autonomous vehicle.

15. The method of claim 13, wherein the vehicle icon is selected to match with a same type of the autonomous vehicle.

16. The method of claim 11, wherein the electronic map is a detailed map showing obstacles in a vicinity of a present location of the autonomous vehicle.

17. The method of claim 16, wherein the obstacles have identifiers (IDs).

18. The method of claim 11, further comprising:
transmitting a message of notifying arrival to the portable terminal after traveling the extracted distance to the caller.

19. The method of claim 11, further comprising:
notifying arrival through a display mounted on an outer portion of the autonomous vehicle after traveling the extracted distance to the caller.
